(19) United States
(12) Patent Application Publication
(10) Pub. No.: US 2002/0164061 A1
(43) Pub. Date: Nov. 7, 2002

(54) Method for detecting shapes in medical images

(76) Inventors: David S. Paik, Palo Alto, CA (US); Geoffrey D. Rubin, Woodside, CA (US); Christopher F. Beaulieu, Los Altos, CA (US); Sandy A. Napel, Menlo Park, CA (US); R. Brooke Jeffrey JR., Los Altos Hills, CA (US)

Correspondence Address: LUMEN INTELLECTUAL PROPERTY SERVICES, 45 CABOT AVENUE, SUITE 110, SANTA CLARA, CA, 95051, US

(21) Appl. No.: 10/137,839

(22) Filed: May 3, 2002

Related U.S. Application Data
(60) Provisional application No. 60/288,621, filed on May 4, 2001.
(60) Provisional application No. 60/288,674, filed on May 4, 2001.

(51) Int. Cl. G06K 9/00

(52) U.S. Cl. 382/131; 382/199; 382/173

(57) ABSTRACT

A computer-implemented method for automatically detecting shapes in a medical image is provided. The method is based on the concept that normals to a surface intersect or nearly intersect with neighboring normals depending on the curvature features of the surface. The method first locates a surface in a medical image after which normal vectors are generated to the located surface. Then the method identifies at least one intersection and/or near intersection of the normal vectors. The key idea is that the number of intersections identifies shapes such as potential malignant candidates. The method also includes the step of scaling normal vectors to provide additional robustness to the shape detection. The method eliminates viewing of large segments of images, thereby markedly shortening interpretation time and improving accuracy of detection. It also provides for an early detection of precancerous growths so that they can be removed before evolving into a frank malignancy.

### CROSS-REFERENCE TO RELATED APPLICATIONS

This application is cross-referenced to and claims priority from U.S. Provisional Applications No. 60/288,621 filed May 4, 2001 and No. 60/288,674 filed May 4, 2002, which are both hereby incorporated by reference. This application is also cross-referenced to co-pending U.S. patent application entitled “Method for characterizing shapes in medical images” filed with the USPTO on May 3, 2002, which is hereby incorporated by reference.

### STATEMENT REGARDING FEDERALLY SPONSORED RESEARCH OR DEVELOPMENT

The present invention was supported in part by grant number R01 CA72023 from the National Institutes of Health (NIH). The U.S. Government has certain rights in the invention.

### FIELD OF THE INVENTION

The present invention relates generally to medical imaging. More particularly, the present invention relates to computer-aided detection of shapes in medical images.

### BACKGROUND

In the United States, lung cancer and colon cancer are the first and second leading cancer killers, respectively. It is known that removal of colonic polyps at a small, precancerous stage will eventually prevent deaths from colorectal carcinoma. Therefore, early detection of precancerous growths or polyps has become important so that they can be removed before evolving into a frank malignancy. The generally agreed upon clinically significant size thresholds for colonic polyps and for lung nodules are about 10 mm and 6 mm, respectively. These thresholds are above the spatial resolution of helical computed tomography (CT). However, the accuracy and the efficiency of viewing many hundreds of source axial images per exam are limited by human factors, such as attention span and eye fatigue.

Volumetric visualization methods, such as perspective volume rendering and virtual endoscopy, have been proposed as alternative methods for interpreting this type of data (See, for instance, U.S. Pat. No. 5,920,319 to Vining et al. and U.S. Pat. No. 6,331,116 to Kaufman et al.). Although, for instance, virtual colonoscopy has been shown to increase the accuracy of colonic polyp detection, the lengthy interpretation times may prevent this method from being used clinically (See, for instance, a paper by C. F. Beaulieu et al. entitled “Display modes for CT colonography. Part II. Blinded comparison of axial CT and virtual endoscopic and panoramic endoscopic volume-rendered studies” and published in Radiology, 212:203-12, 1999; a paper by D. S. Paik, et al. entitled “Visualization modes for CT colonography using cylindrical and planar map projections” and published in Journal of Computer Assisted Tomography, 24:179-88, 2000; or a paper by A. K. Hara et al. entitled “Colorectal polyp detection with CT colography: two- versus three-dimensional techniques” and published in Radiology, 200:49-54, 1996.).

A variety of computer-aided detection (CAD) methods have been developed to improve both the accuracy and the efficiency of interpretation for 3D diagnostic problems, including lung nodule detection from CT and colonic polyp detection from CT (See, for instance, U.S. Pat. No. 5,657,362 to Giger et al. or U.S. Pat. No. 5,987,094 to Clarke et al.). However, with current image interpretation methods, achieving a significant cost-reduction of CT is still challenging due to the anticipated high costs of professional charges for the radiologist's interpretation. A significant cost reduction can only be achieved if the length of interpretation is dramatically reduced and more closely approximates to the time of other screening imaging techniques such as mammography.

Accordingly, there is a need to develop CAD techniques to identify potentially abnormal areas so that a radiologist could focus in on the small percentage of the organ or tissue most likely to harbor a clinically-significant malignant tissue. Such a technique would eliminate viewing of long segments of normal tissue, thereby markedly shortening interpretation time and improving the accuracy of detection.

### SUMMARY OF THE INVENTION

The present invention provides a computer-implemented method for automatically detecting shapes in a medical image. The method of the present invention enables a user, such as a radiologist, to focus in on the small percentage of the organ or tissue that most likely harbors a clinically-significant malignant tissue. Focusing in on a small percentage of an organ or tissue significantly reduces the time spent by a user on interpreting, reviewing or detecting shapes in a medical image and therewith reduces the cost on medical diagnostics. The present invention can be applied to detecting polyps, lesions, nodules, or the like. The medical images of the present invention are digital or computerized images such as, for instance, but not limited to, a CT, an MRI, a digitized X-ray, or any other medical image application that could be converted or rendered to a digital image. The medical images could be a 2-D image or a 3-D volumetric image.

The present invention is based on the concept that normals to a surface, such as, but not limited to a colonic surface or lung, intersect or nearly intersect with neighboring normals depending on the curvature features of the colon or lung respectively. The method first locates a surface in a medical image after which normal vectors are generated to the located surface. For shapes protruding into the colon, normal vectors intersect on the concave side of the shape. For instance, polyps have shapes that change rapidly in any direction such that normals to the surface tend to intersect or nearly intersect in a concentrated area. By contrast, haustral folds change their shape rapidly when sampled across their short dimension, resulting in convergence of normals, but change shape very little when sampled longitudinally. This results in a relatively lower intensity of the convergence for haustrae as compared with a polyp of similar cross-sectional radius of curvature. In other words, at convexities, normals tend to intersect on a concave side of a polyp. Accordingly, the method of the present invention then identifies at least one intersection and/or near intersection of the normal vectors. The key idea is that the number of intersections identifies shapes such as potential polyp candidates.

The method of the present invention also includes the step of scaling normal vectors. Scaling of normal vectors provides additional robustness and includes scaling of the length and/or width of the normal vectors. Such scaling is also referred to as the step of providing radial and transverse robustness, respectively. The contribution of each individual normal vector is dependent on the distance from the surface edge element and the perpendicular distance from the normal vector. As one of average skill in the art will readily appreciate, scaling normal vectors and the extent to how much scaling is appropriate, is dependent on the type of shapes a user wants to detect in a particular organ or tissue.

In view of that which is stated above, it is the objective of the present invention to provide a computer-implemented method for automatically detecting shapes in a medical image.

It is another objective of the present invention to provide a computer-implemented method to generate normal vectors at the surface in a medical image.

It is yet another objective of the present invention to provide a computer-implemented method to determine normal vectors that intersect or nearly intersect with neighboring normal vectors depending on the curvature features of the shape.

It is still another objective of the present invention to focus in on the small percentage of the organ or tissue that most likely harbors a clinically-significant malignant tissue based on the intersections or near intersection of normal vectors.

The advantage of the automated method of the present invention is that it eliminates viewing of long segments of normal tissue, thereby markedly shortening interpretation time and improving the accuracy of detection. Another advantage of the present invention is that it allows a user to focus in on a small area to detect potential shapes of interests such as malignant tissue. Yet another advantage of the present invention is that it provides for an early detection of precancerous growths so that they can be removed before evolving into a frank malignancy. The present invention provides an efficient method that is considerably more efficient than current human viewing interpretation and enabling a cost-effective medical test to be widely deployed for screening purposes.

### BRIEF DESCRIPTION OF THE FIGURES

The objectives and advantages of the present invention will be understood by reading the following detailed description in conjunction with the drawings, in which:

FIG. 1 shows a method of locating and detecting a shape in a medical image according to the present invention;

FIG. 2 shows a method of locating and detecting a shape in a medical image including the step of scaling normal vectors according to the present invention;

FIGS. 3-6 show several embodiments related to a 2-D representation of the methods shown in FIGS. 1-2;

FIG. 7 shows an example of a colonic polyp in a medical image according to the present invention;

FIG. 8 shows an example of a pre-processed data showing a limited search space according to the present invention;

FIG. 9 shows an example of the result of an edge detection, which marks the surface of the polyp according to the present invention;

FIG. 10 shows the result of an example in which the counts of intersecting normal vectors were scaled in width using a low-pass filter to add, for instance, transverse robustness to the detection of shapes according to the present invention;

FIG. 11 shows a method of characterizing a shape in a medical image according to a method that could be used in the present invention;

FIG. 12 shows medical images with some examples of candidate shapes in a lung according to the present invention;

FIGS. 13-15 show exemplary embodiments of a characterization of a shape according to a method that could be used in the present invention;

FIG. 16 shows an example of candidate shapes that were correctly accepted as being lung nodules by a method that could be used in method of the present invention;

FIG. 17 shows examples of candidate shapes, shown within the ovals, which were correctly rejected as being vessels by a method that could be used in the present invention; and

FIG. 18 shows different examples of candidate shapes that were characterized by a method that could be used in the present invention.

### DETAILED DESCRIPTION OF THE INVENTION

Although the following detailed description contains many specifics for the purposes of illustration, anyone of ordinary skill in the art will readily appreciate that many variations and alterations to the following exemplary details are within the scope of the invention.

Accordingly, the following preferred embodiment of the invention is set forth without any loss of generality to, and without imposing limitations upon, the claimed invention.

The present invention provides a robust and highly sensitive computer-implemented method for automatic detection of one or more shapes in a medical image. The present invention enables a user, such as, but not limited to, a radiologist, to focus in on a small percentage of an organ or tissue that most likely harbors clinically-significant malignant tissue. Focusing in on a small percentage of an organ or tissue significantly reduces the time spent by a user on interpreting, reviewing or detecting shapes in a medical image and therewith reduces the cost on medical diagnostics.

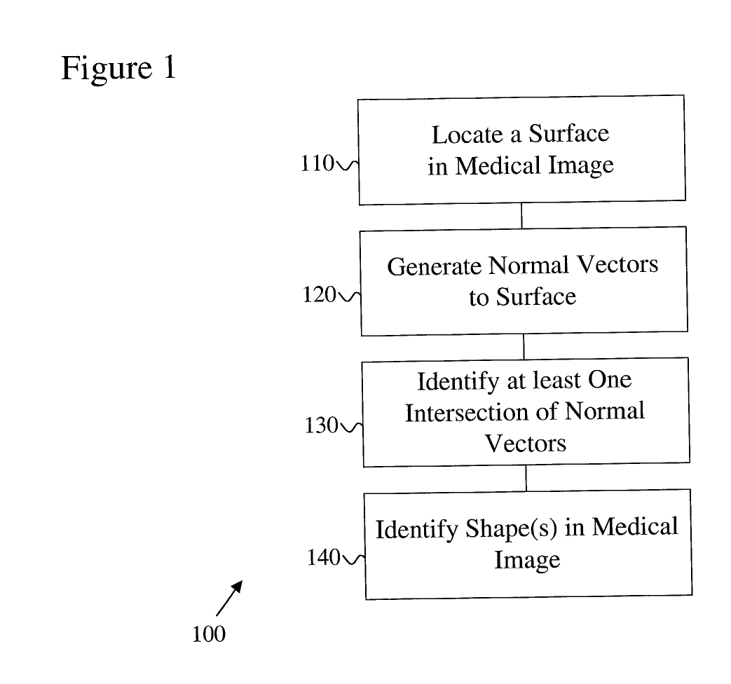

FIG. 1 shows an example of a method 100 according to the present invention to detect one or more shapes in a medical image. The medical images of the present invention are digital or computerized images such as, for instance, but not limited to, a CT, an MRI, a digitized X-ray, or any other medical image application that could be converted or rendered to a digital image. The medical images could be a 2-D image or a 3-D volumetric image. For illustration purposes, the present invention is described below in the context of detecting colonic polyps from a CT image. However, as one of average skill in the art will readily appreciate, the method of the present invention can be applied to detecting similar structures or shapes in any medical imaging application. For example, other applications include, but are not limited to, detecting lesions, nodules (such as liver nodules or lung nodules) or the like. The present invention is based on the concept that normals to a surface, such as, but not limited to a colonic surface or lung, intersect or nearly intersect with neighboring normals depending on the curvature features of the colon or lung respectively.

Referring to FIG. 1, first a surface is located 110 in the medical image after which the normal vectors are generated 120 to the located surface. There are several different ways to identify a surface in a medical image and are mostly dependent on the type of image or tissue. In general, the identification could involve a pre-processing and/or segmentation of the image. For instance, since the edges of both colonic polyps and lung nodules occur at an air-soft tissue interface, the soft tissue-bone interfaces may need to be removed by, for instance, but not limited to, clamping voxel intensities to be no greater than water intensity (0 HU). Then, the volume data could be made isotropic by tri-linear interpolation of the CT data to, for instance, but not limited to, 0.6 mm×0.6 mm×0.6 mm voxels. This step, although not strictly necessary, could be done in order to reduce any bias between lesions caused by differing orientations and also to reduce any bias between datasets caused by differing voxel sizes.

Another step in the identification of a surface could be segmentation. Segmentation is preferably performed automatically to identify, for instance, either the colon lumen or the lung parenchyma. A binary image, S₁, is created by thresholding all air intensity voxels (e.g. <−700 HU) followed by a negative masking of all air intensity voxels morphologically connected to any of the edges of the dataset, thus leaving only air density voxels within, for instance, the abdomen. In case of the colon, any portions of the lungs that are captured at the top of the dataset could also be removed by a negative mask of a 3D region filling seeded with air intensity regions in the most superior axial slice with a linear extent of greater than for example 60 mm. Finally, small air pockets (<15 cc in the colon datasets, <125 cc in the lung datasets) could be determined to be extraneous and are negatively masked from the binary image. Next, a binary image, S₂ could be derived from S₁ and be used to limit the search space to voxels near the air-tissue interfaces in either the colon or the lung. This could serve two purposes; primarily, it reduces the computational overhead by approximately two orders of magnitude. It also reduces a few false positives arising from soft tissue structures outside the organ of interest. S₂ begins as the surface voxels of S₁ and then is morphologically dilated by for instance 5 mm to produce a thick region that contains the image edges of interest.

For shapes protruding into the colon, normal vectors intersect on the concave side of the shape. For instance, polyps have 3-D shapes that change rapidly in any direction such that normals to the surface tend to intersect or nearly intersect in a concentrated 3-D area. By contrast, haustral folds change their shape rapidly when sampled across their short dimension, resulting in convergence of normals, but change shape very little when sampled longitudinally. This results in a relatively lower intensity of the convergence for haustrae as compared with a polyp of similar cross-sectional radius of curvature. In other words, at convexities, normals tend to intersect on a concave side of a polyp. Accordingly, the method of the present invention then identifies 130 at least one intersection and/or near intersection of the normal vectors. The key idea is that the number of intersections identifies 140 3-D shapes such as potential polyp candidates. Generating normal vectors could, for instance, be accomplished by using a gradient orientation calculation to detect high image gradient edges and determine the 3-D orientation of an image gradient. For instance, a Canny edge detector could be used or any other edge detector technique to determine the orientation of an image gradient.

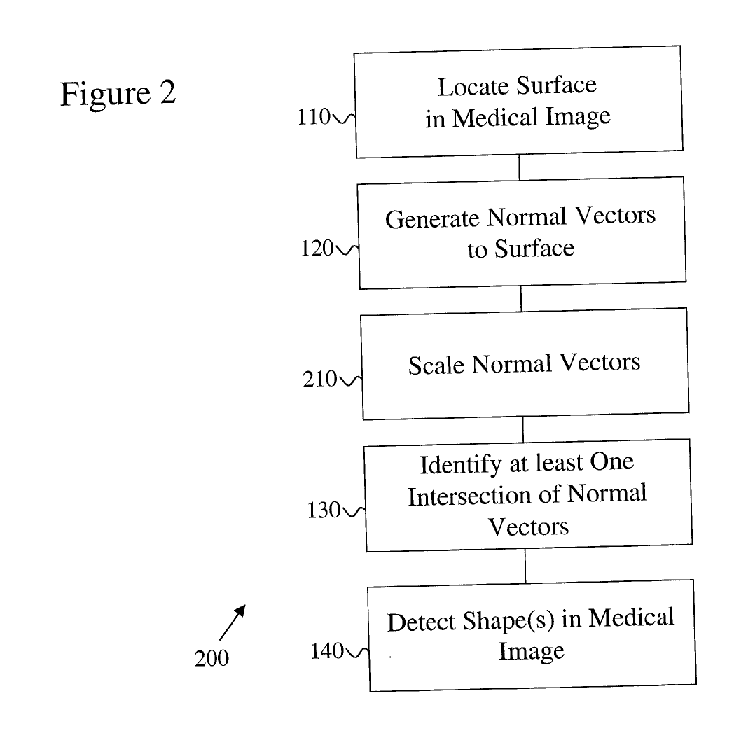

FIG. 2 shows the identical methods steps as shown in FIG. 1 except for the addition of the step of scaling normal vectors 210. Scaling normal vectors 210 provides additional robustness to the method as shown in FIG. 1 and includes scaling of the length and/or width (either in a 2-D or 3-D space) of the normal vectors. Such scaling is also referred to as the step of providing radial and transverse robustness, respectively. The contribution of each individual normal vector is then dependent on the distance from the surface edge element and the perpendicular distance from the normal vector. As one of average skill in the art will readily appreciate, scaling normal vectors 210 and the extent to how much scaling is appropriate, is dependent on the type of shapes a user wants to detect in a particular organ or tissue. To accomplish scaling of normal vectors 210, the input to the gradient orientation calculation could be modified. For instance, the input to the Canny edge detector could be modified.

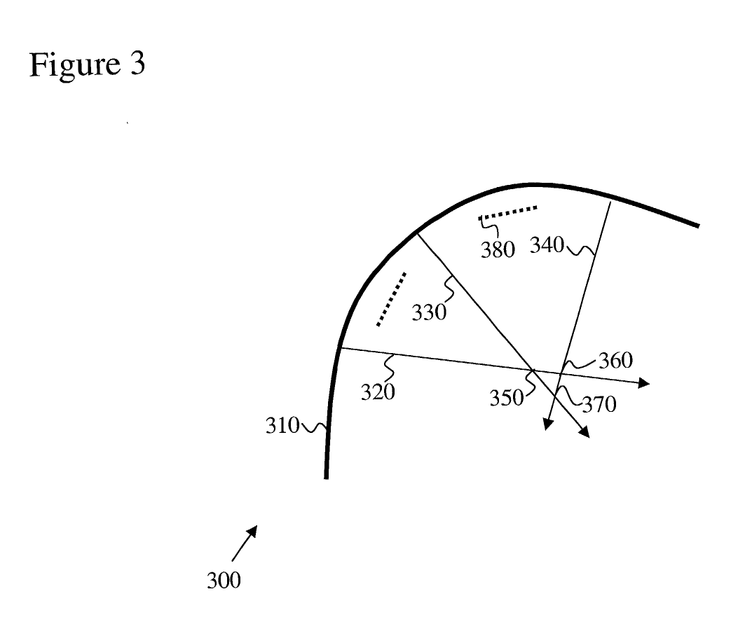

FIGS. 3-6 show several embodiments related to a 2-D representation of the method according to the present invention. However, as one of average skill in the art will readily appreciate, these examples are meant to be illustrative, and not limiting to 2-D medical images or 2-D applications of the invention since the present invention is preferably used in relation to 3-D medical images and detect 3-D shapes. FIG. 3 shows medical image 300 with a surface 310. In this example, three normal vectors 320, 330 and 340 are generated to surface 310. However, as indicated by the dotted lines, such as 380, the present invention is not limited to three normal vectors and could be a plurality of normal vectors. The choice and selection of the number of normal vectors that needs to be generated is dependent on the type of image as well as on the resolution of the image or voxels, and dimensions of the normal vectors generated in the image. As discussed above, the present invention focuses on identifying at least one intersection of normal vectors. FIG. 3 shows normal vectors 320 and 330 intersecting at point 350, normal vectors 320 and 340 intersecting at point 360, and normal vectors 330 and 340 intersecting at point 370. As also discussed above, the example of FIG. 3 generates intersections in a 2-D space with X and Y coordinates in the 2-D image. If image 300 were a 3-D image, the intersections would be in a 3-D space with X, Y and Z coordinates in the 3-D image.

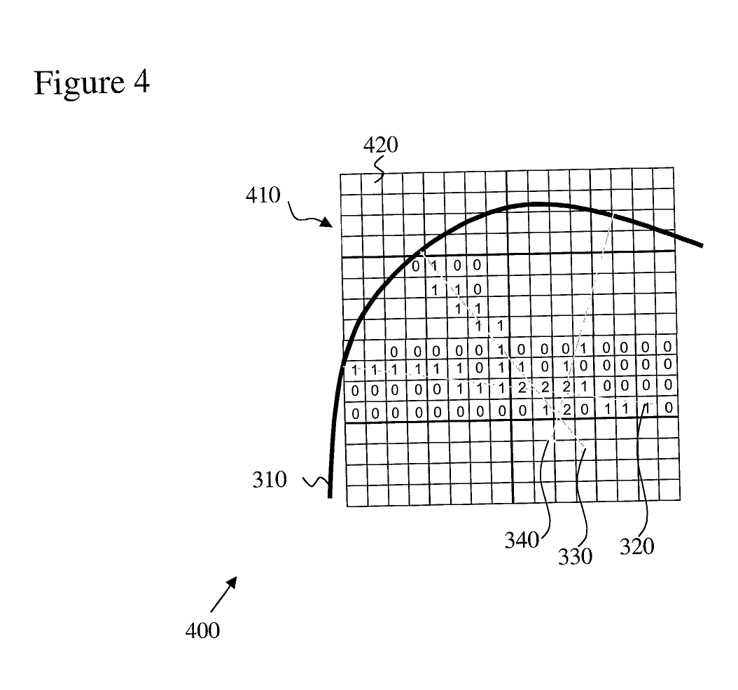

FIG. 4 shows the same image as shown by 300 in FIG. 3 with the difference that image voxels 410 are shown in image 400. Furthermore, FIG. 4 shows an example of how the present invention could keep track of the number of overlapping normal vectors. In this particular example, a 0 is used when a normal vector does not cross with an image voxel (420 is an example of an image voxel in 410) and a 1 is used when a normal vector does cross with an image voxel. In case two normal vectors intersect a value of 2 is assigned to that voxel. As one of average skill in the art will readily appreciate, the number of intersections for a particular image voxel would increase the number of normal vectors assigned to that particular image voxel by increments of 1 according to this example. The tracking of intersections by integer numbers is just one example and the present invention is not limited to only integer numbers and could also include non-integers numbers. Any type of numbering system could be used, but it is not limited to, a mathematical formulation, a coloring scheme, or the like, as long as one is able to track and discriminate the number of intersections of the normal vectors in a 2-D or 3-D space of an image. Furthermore, the present invention is not limited to tracking the number of intersections, since it could also track potential or near intersections of normal vectors, either separate or in combination with the intersections of normal vectors.

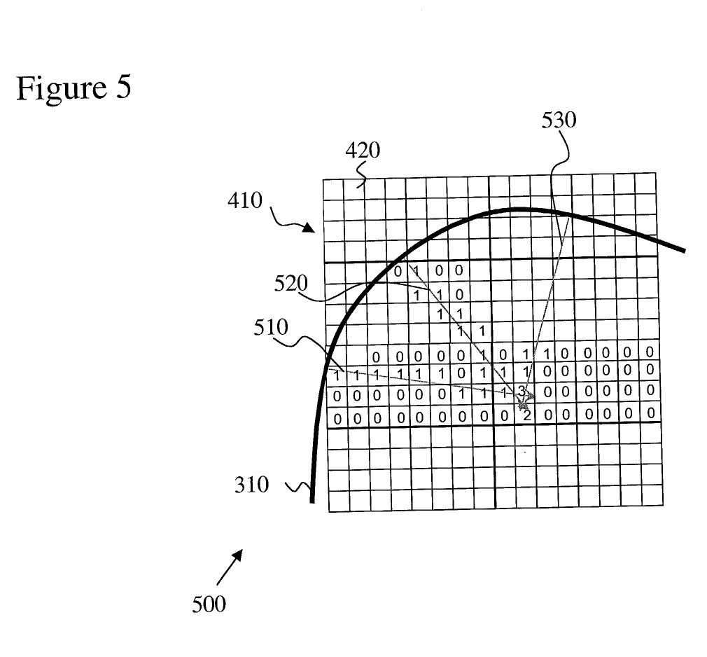

FIG. 5 shows a similar image as shown by 300 and 400 in FIGS. 3 and 4 with the difference that normal vectors 510, 520 and 530 are scaled according to a specific length which provides additional robustness (i.e. radial robustness) to the detection of shapes. Adjusting the length of the normal vectors could be achieved, for instance, but not limited to, scan-converting to a specific length the line segments or normal vectors that point in the direction of the gradient orientation. One of average skill in the art will readily appreciate that the length of the scan-conversion is dependent on the type of detection.

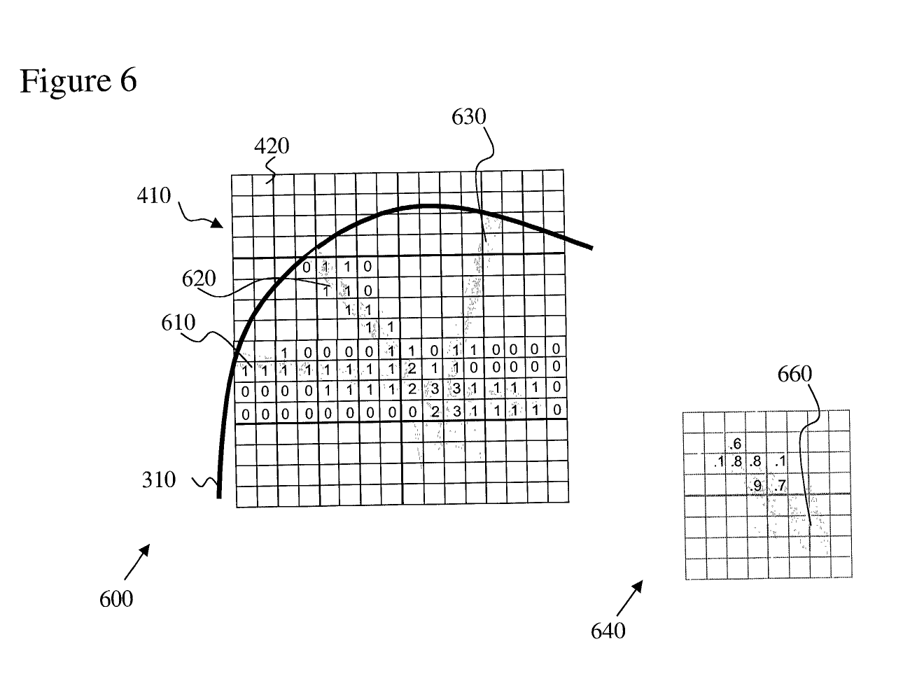

Furthermore, FIG. 6 shows a similar image as shown by 300 in FIG. 3 with the difference that normal vectors 610, 620 and 630 are now scaled according to a specific width which is specified in this example as a 2-D width, but could also be a 3-D width in a 3-D image. Such a scaling of the normal vectors provides additional robustness (i.e. transverse robustness) to the detection of shapes. Transverse robustness is added, for instance, but not limited to, by using thickened line segments with a Gaussian profile rather than e.g. one voxel thick line segments. This could, for instance, be achieved by convolving the normal vectors with a 3-D Gaussian, which could be implemented as a series of 1D convolutions for computational efficiency. For example, a discretized kernel could be chosen to include ±2σ to cover 95% of the Gaussian curve. However, the present invention is not limited to a Gaussian convolution and could include any variation or method to convolute the normal vectors. FIG. 6 also shows example 640 to show how non-integer numbers could be used to determine the degree to which a normal vector covers a voxel. A similar non-integer numbering could be applied for near intersections of normal vectors.

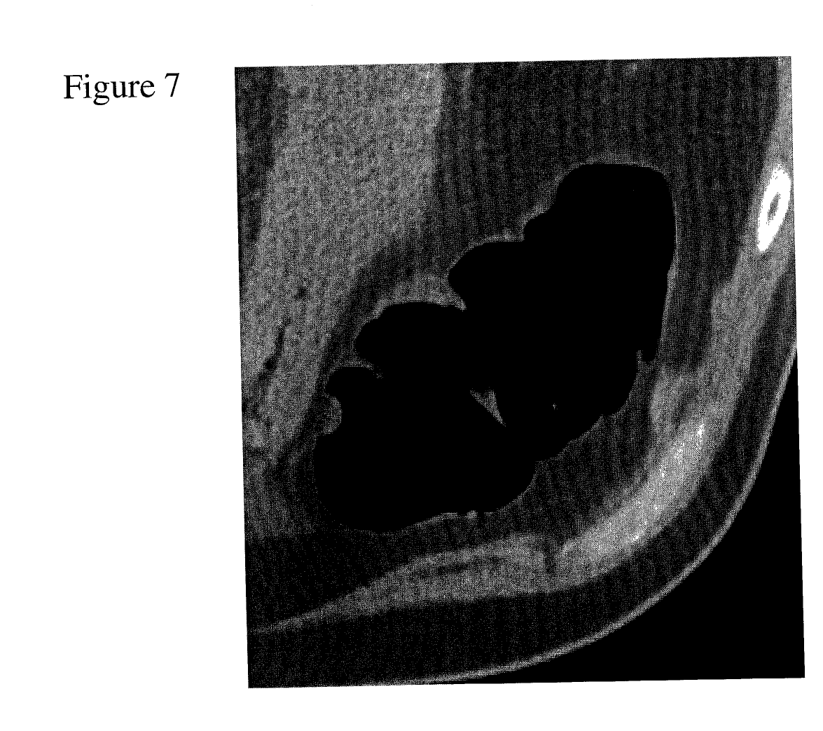

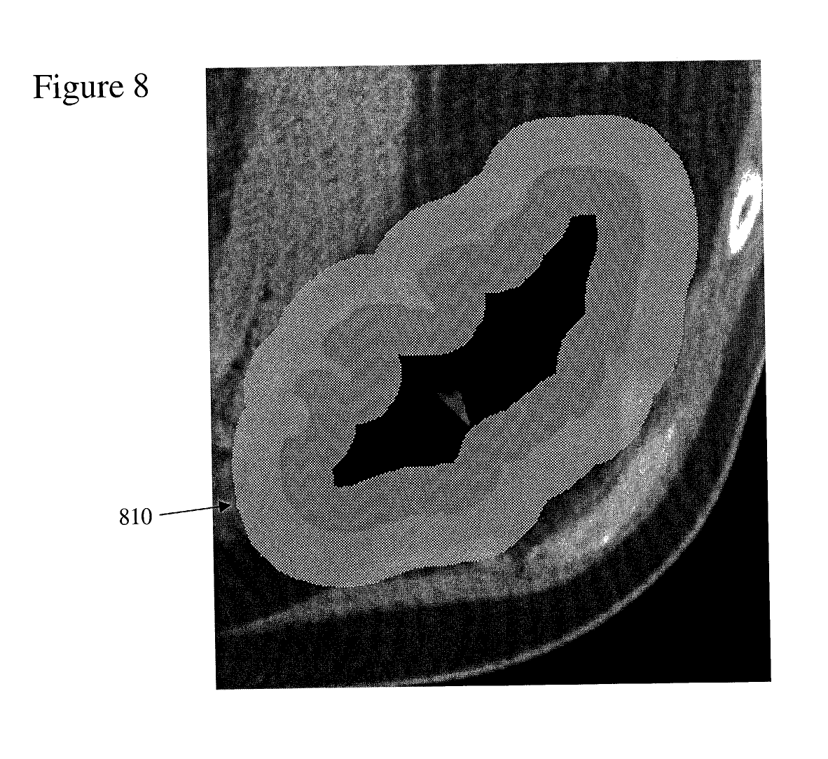

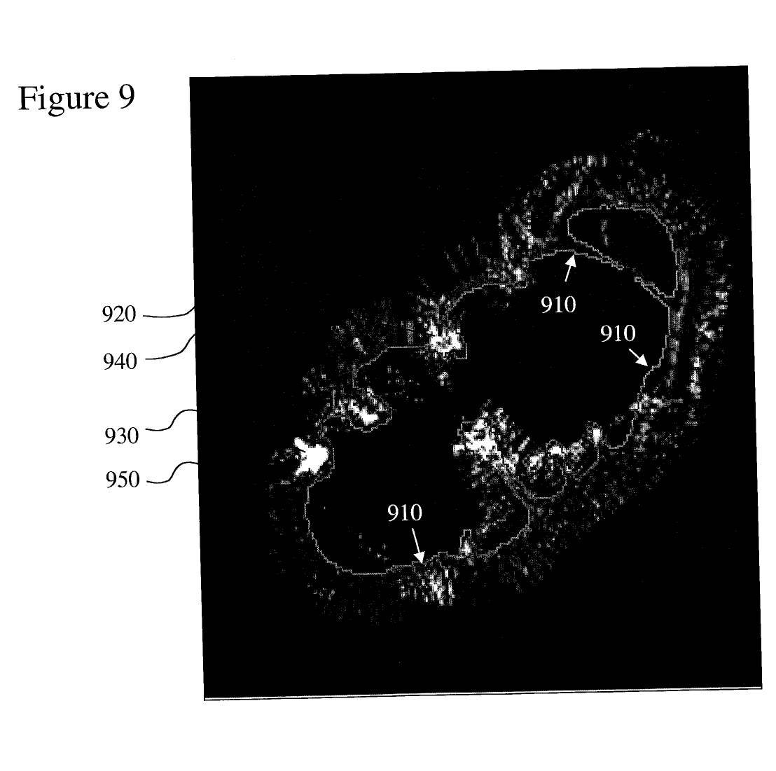

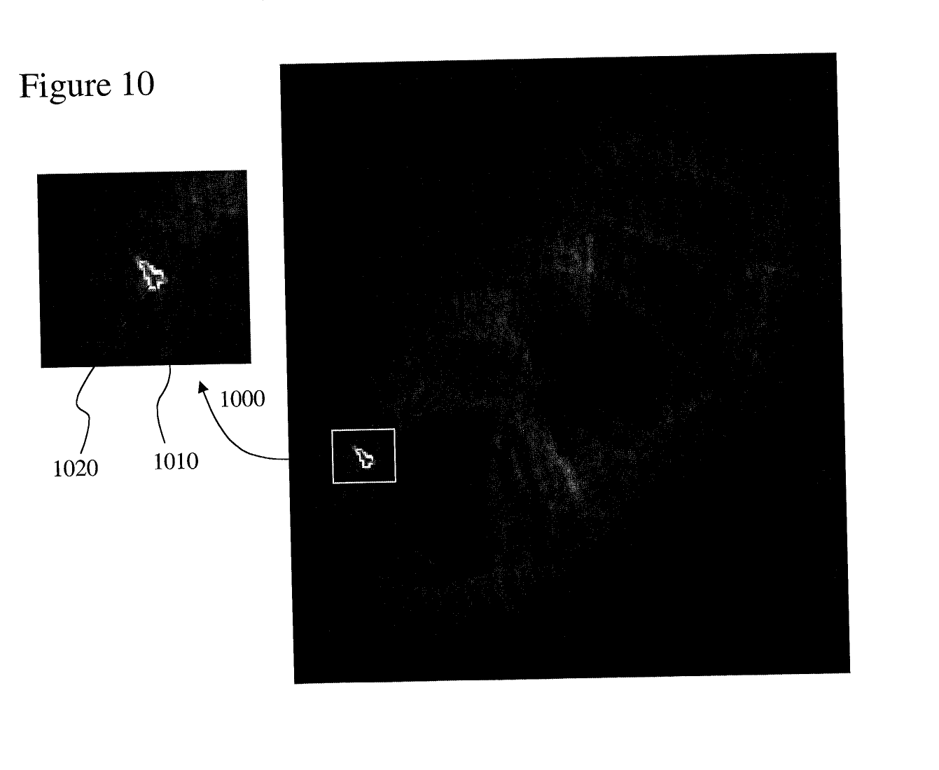

FIG. 7 show an example of a colonic polyp in a medical image according to the present invention. FIG. 8 shows an example of a pre-processed data showing a limited search space 810. FIG. 9 shows an example of the result of edge detection which marks the surface of the polyp. Arrows 910 indicate only some points of the entire edge detection line which is visible in FIG. 9. FIG. 9 also shows the number of intersecting normal vectors 920, 930, 940 and 950 with different color intensities or gray scales. As it is apparent from FIG. 9, a radiologist is now able to focus in on a small percentage of an organ that most likely harbors clinically significant malignant tissue. For instance, area 930 indicates the highest probability of clinically significant malignant tissue over areas 920, 940 and 950 based on the detection method of the present invention. Among these four areas, area 950 has the least probability of containing clinically significant malignant tissue based on the detection method of the present invention. As mentioned above, the present invention is not limited to a coloring scheme or gray scale to indicate the degree of clinically significant malignant tissue since it could also be a numerical scheme or the like. FIG. 10 shows the result of an example in which the counts of intersecting normal vectors were scaled in width using a low-pass filter to add, for instance, transverse robustness to the detection of shapes. Insert 1000 in FIG. 10 shows two areas 1010 and 1020 with different degrees of clinically significant malignant tissue. In this particular example of FIG. 10, area 1010 has a higher probability than area 1020 of being clinically significant malignant tissue. FIG. 10 shows that a radiologist could clearly focus in on a small percentage of an organ that most likely harbors clinically significant malignant tissue. As one of average skill in the art would readily appreciate, the present invention could use different techniques or filters to determine a threshold and detect tissue in the image that contains clinically significant malignant tissue.

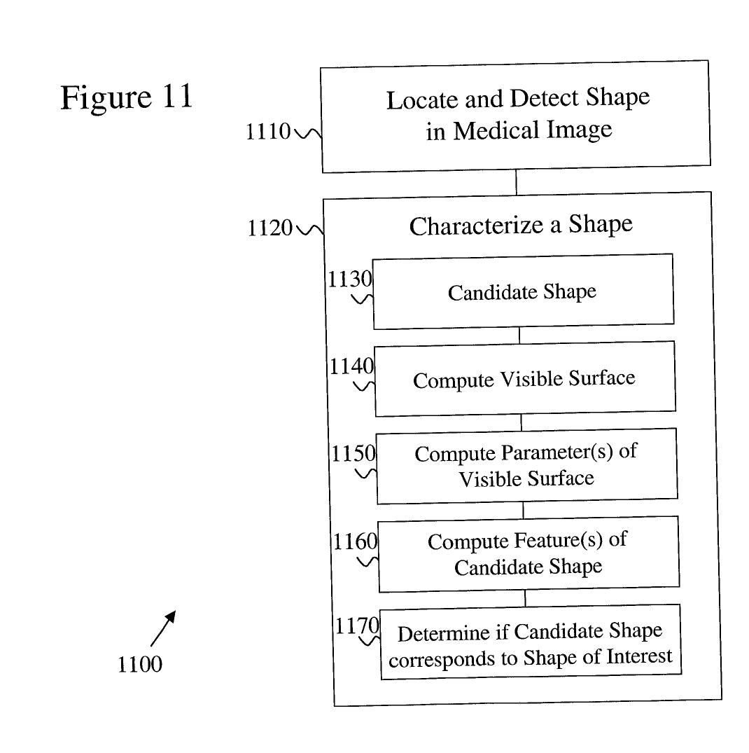

As described so far, the present invention provides a computer-implemented method aimed at a high sensitivity or accuracy of detection of shapes in medical images. However, in some cases the increased sensitivity could lead to a false positive rate due to e.g. structures in the colon or lung with convex surfaces, such as haustral folds or pulmonary blood vessels. Therefore, it would be necessary for the present invention to include an additional step to eliminate false positives by examining the region around a shape and eliminate such a false positive area. A preferred method for characterizing a shape with the aim of eliminating false positives is described with reference to FIGS. 11-18 as well as in co-pending U.S. patent application entitled “Method for Characterizing Shapes in Medical Images” filed with the U.S.P.T.O. on May 3, 2002. The present invention is in no way limited to this particular preferred method step as described in this co-pending application and which is herein described for completion.

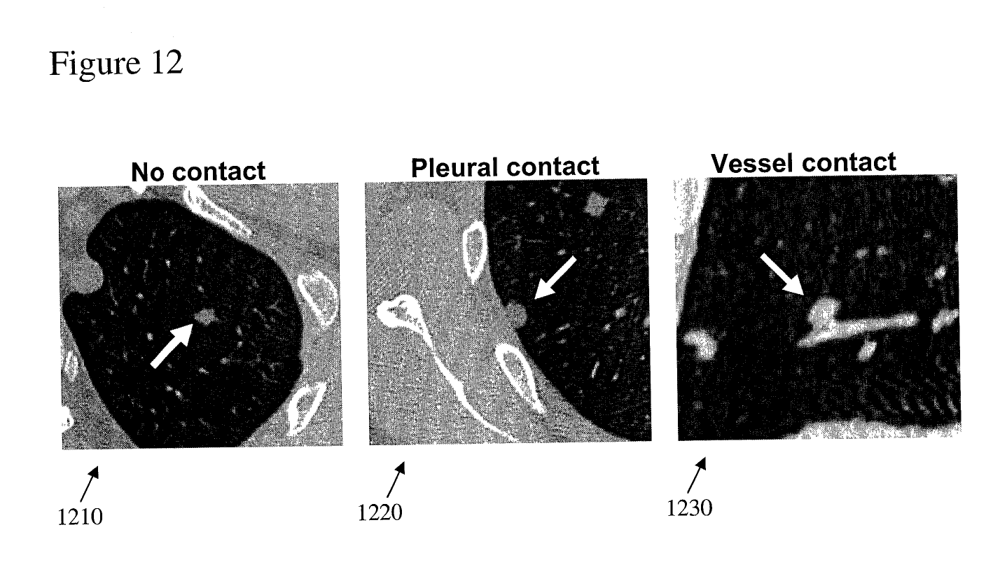

Referring to FIG. 11, once the localization and detection 1110 of a shape has been accomplished, the shape can then be characterized 1120. The essence of characterizing shape 1120 is in using line of sight visibility 1140 with respect to a candidate shape 1130 as a measure of physical proximity to eliminate false positives that are due to structures or shapes in, for instance, the colon or lung with convex surfaces, such as haustral folds or pulmonary blood vessels. A detection due to false positive structures is usually based on the shape of the structure, which is often adjacent to normal or other distinct anatomical structures. For instance, a colonic polyp is always attached to the colon wall and some lung nodules are adjacent to either the chest wall or pulmonary vessels. FIG. 12 shows medical images with some examples of candidate shapes in a lung where the candidate shapes are indicated by arrows. The candidate shapes in FIG. 12 have either no contact to a vessel or pleura, have pleural contact or have vessel contact as respectively shown in 1210, 1220 and 1230.

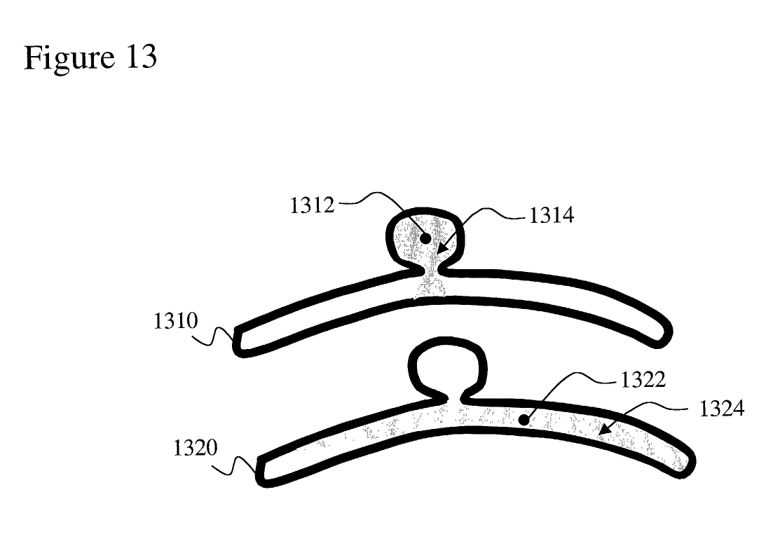

FIG. 13 shows exemplary embodiments of characterization 1120 (see FIG. 11) of candidate shapes. A candidate shape is obtained and a location in the candidate shape is identified or selected. For instance, location 1312 is selected in an exemplary lung nodule, adjacent to a pulmonary vessel 1310, whereas location 1322 is selected within pulmonary vessel 1320.

Referring to FIG. 11, at each candidate shape 1130, a visible surface is computed 1140 with respect to the location (e.g. 1312 and 1322 in FIG. 13) in the candidate shape (this is also referred to as a local segmentation or computing a local surface). From the location in a candidate shape, all of the visible surface voxels are identified or computed 1140. Visibility or visible surface voxels could be defined to mean, for instance, but not limited to, that all voxels along a scan-converted line between two voxels are above a certain threshold. For instance, but not limited to, visibility or visible surface voxels could be defined to mean that all voxels along a scan-converted line between two voxels are above a −500 HU threshold with a 6-neighbor contiguous region of the structure's surface visible from the candidate shape. Among all of the contiguous pieces of visible surface, the one voxel closest to the candidate shape position is chosen. This set of voxels is then considered the closest contiguous visible surface. As one of average skill in the art would readily appreciate, the present invention is not limited to the level of intensity or the number of neighbors in order to define visibility.

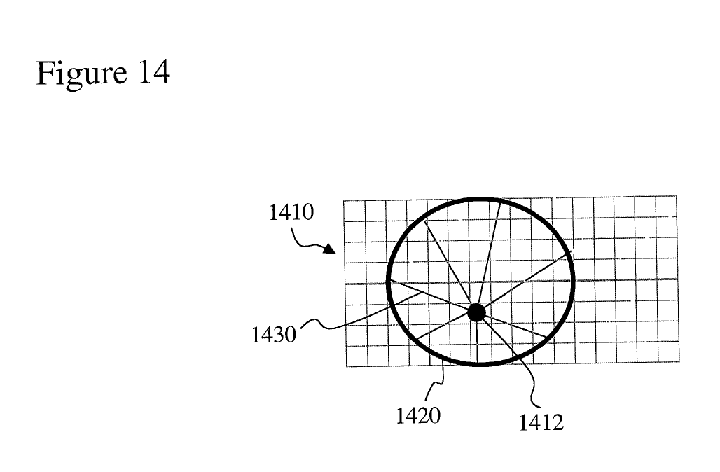

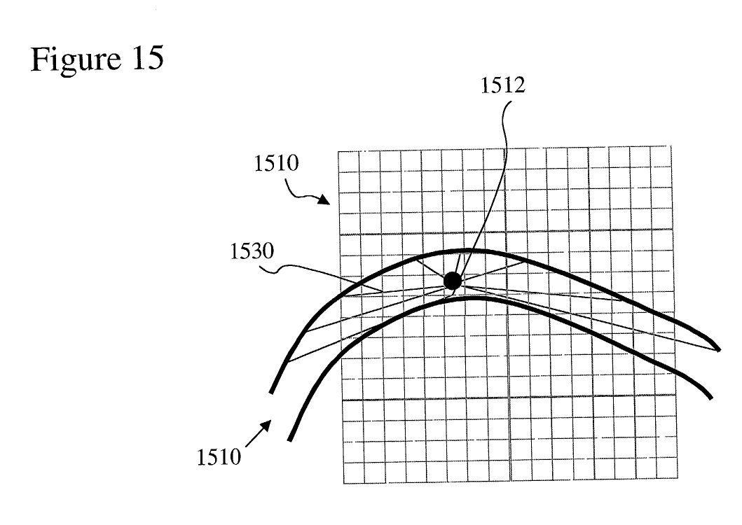

With respect to locations 1312 and 1322 in FIG. 13, visible surfaces 1314 and 1324 (also indicated by the gray areas in FIG. 13) are computed, respectively. FIG. 14 shows an example of a location 1412 in a candidate shape located in a particular voxel in an anatomical structure 1420 with respect to voxels 1410. Lines, such as 1430, indicate the line of sight for location 1412 in anatomical structure 1420. FIG. 15 is another example of a location 1512 in a candidate shape located in a particular voxel in a anatomical structure 1520 with respect to voxels 1510. Lines, such as 1530, indicate the line of sight for location 1512 in anatomical structure 1520. FIGS. 14 and 15 shows a 2-D representation of a medical image, however, as mentioned above, the present invention includes 2-D and 3-D medical images and therefore the characterization of a candidate shape includes either a 2-D or 3-D line of sight visibility as a measure of physical proximity. Note that an analogy to the concept of line of sight is the area that is covered by a light shining in all directions and originating from a location in a candidate shape.

After the visible surface has been computed 1140, one or more parameters of the visible surface could be computed 1150. An example of computing 1150 one or more parameters of the visible surface is by using, for instance, but not limited to, a principle components analysis (PCA) of the coordinates of the points on the visible surface. Other variations might include replacing the PCA with something similar such as a higher order independent components analysis. A PCA, also known as Karhunen-Loeve transform, could be performed on the spatial coordinates of each voxel in the closest contiguous visible surface which then yields parameters of the visible surface adjacent to the candidate shape. For instance, the PCA computes three eigenvalues (e1>e2 >e3) that are representative of the major and minor axes of the ellipsoid that best fit the surface. The largest eigenvalue, e1, corresponds to the maximum dimension and the ratio of the smallest to the largest eigenvalues, e3/e1, corresponds to aspect ratio. For each candidate shape 1130 one or more features 1160 could be computed, derived or determined, such as, but not limited to, the number (or score) of intersections or near intersections of normal vectors based on detection 1110, the size, and/or diameter (a transform converts the eigenvalues to diameter measurements: e.g. dᵢ≅3.45·\sqrt{eᵢ} where i∈{1,2,3}.), or the like.

Based on the one or more features of the candidate shape it would be possible to determine 170 whether or not, or to what extent, the candidate shape corresponds to a shape of interest; e.g. the degree of certainty whether or not the candidate shape fits the description of a shape of interest or fits a classification to which the candidate shape could be classified. Based on the one or more features, it could also be determined 1170 whether or not the candidate shape should be considered as a shape of interest that contains malignant tissue or is cancerous tissue. As a person of average skill in the art would readily appreciate is that different features could be translated or linked to medical descriptors of diseases, medical diagnostics, or the like.

Parameters and/or features are useful to determine whether or not a candidate shape corresponds to a shape of interest. For instance, small values of e3/e1 tend to indicate rod-like or sheet-like structures, such as, pulmonary vessels or haustral folds. Additionally, large values of e1 tend to indicate non-lesions as well. For instance, candidate lung nodules, could rejected as being vessels if d1 is larger that 20 mm (too long to be a lung nodule), or if d3/d1 is less than 0.35 (too elongated to be a lung nodule). However, a candidate lung nodule, is not rejected if the line segment from the candidate lung nodule position to the voxel directly below it (inferior) on the edge of the dataset does not intersect lung tissue. Lung tissue could be segmented by region growing from within the lung parenchyma with a threshold of, for instance, but not limited to, −500 HU. This exception accepts lung nodules contacting the pleura on the bottom of the lung (near liver or mediastinum), which may have a very large closest contiguous visible surface due to the concavity of the lung near the liver or mediastinum.

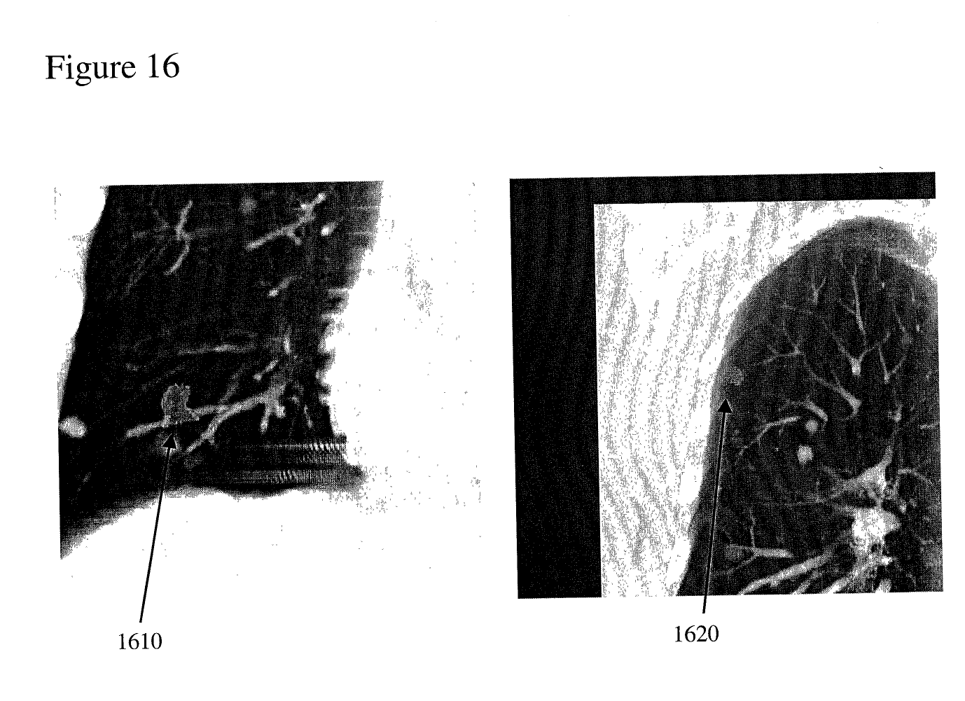

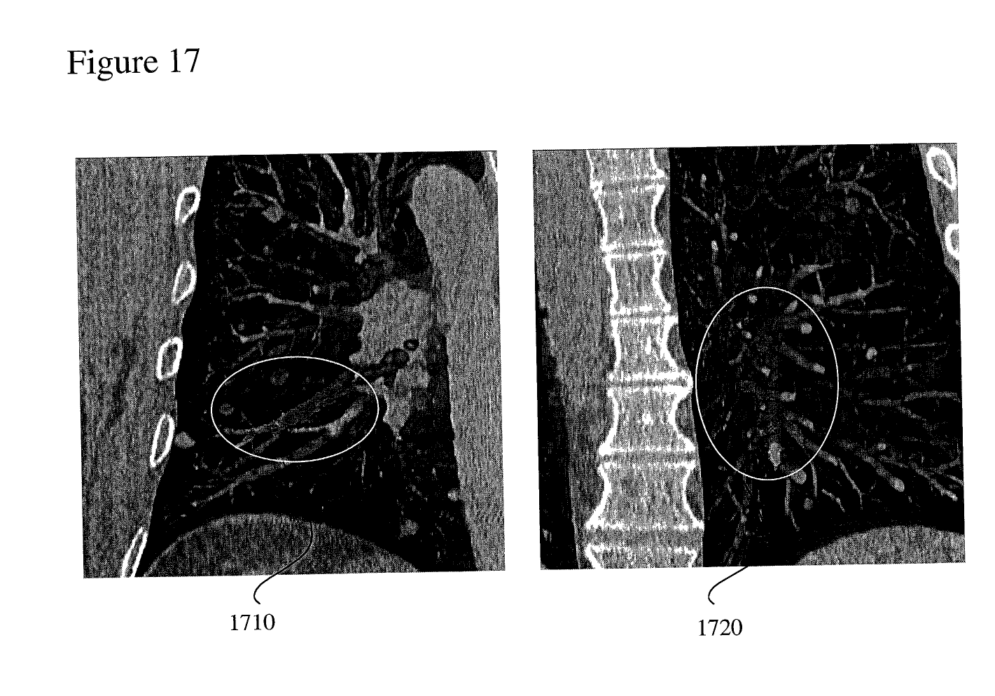

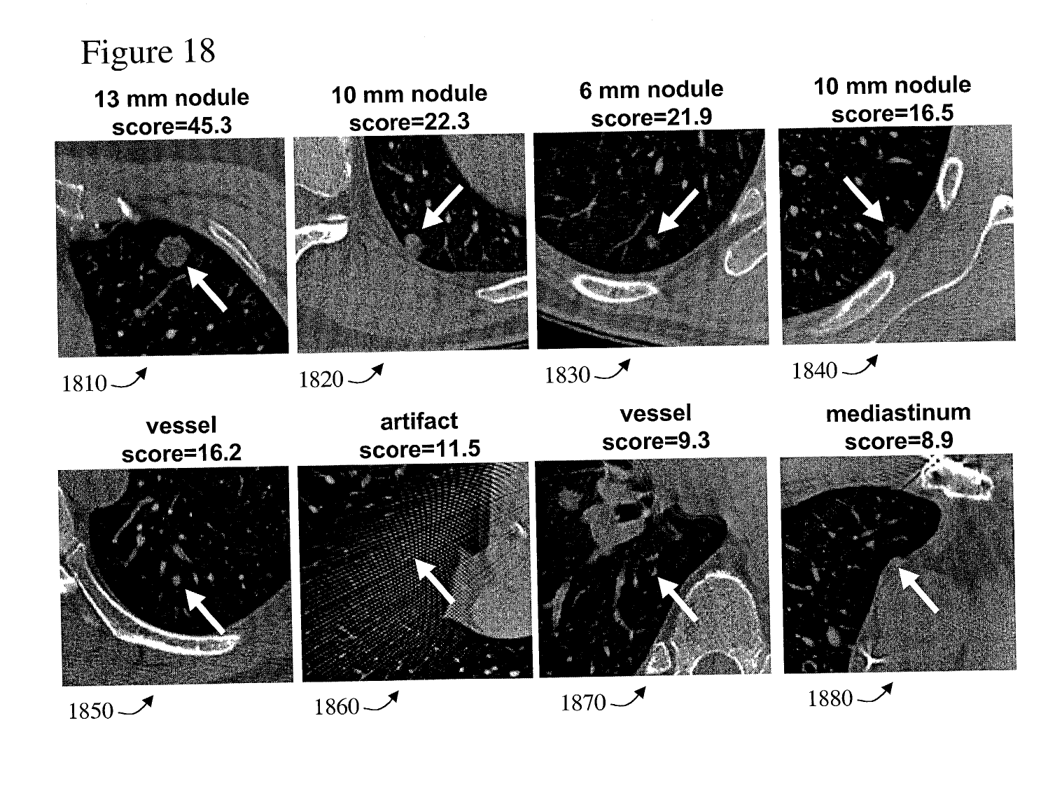

FIG. 16 shows an example of candidate shapes 1610 and 1620 that were correctly accepted by the method of the present invention as lung nodules. 1610 is an example of a lung nodule with vessel contact and 1620 is a lung nodule with pleural contact. FIG. 17 shows examples of candidate shapes, shown within ovals 1710 and 1720, which were correctly rejected by the method of the present invention as being vessels. FIG. 18 shows different examples of candidate shapes (each indicated by an arrow) with a score, the computed size of the shape and the determination whether or not the shape is considered to be a lung nodule. Candidate shapes indicated by arrows in 1810, 1820, 1830 and 1840 are considered to be lung nodules, whereas candidate shapes indicated in 1850, 1860, 1870 and 1880 by arrows are considered to be a vessel, artifact, vessel and mediastinum, respectively.

The present invention has now been described in accordance with several exemplary embodiments, which are intended to be illustrative in all aspects, rather than restrictive. Thus, the present invention is capable of many variations in detailed implementation, which may be derived from the description contained herein by a person of ordinary skill in the art. As one of average skill in the art would readily appreciate, the present invention could be implemented using a variety of different computer languages and operating systems and is not limited to a particular platform, language or system. All such variations are considered to be within the scope and spirit of the present invention as defined by the following claims and their legal equivalents.

What is claimed is:

1. A computer-implemented method for automatically detecting shapes in a medical image, comprising:
a) locating a surface in said medical image;
b) generating a plurality of normal vectors to said surface; and
c) identifying at least one intersection or near intersection of said normal vectors.

2. The method as set forth in claim 1, wherein said identifying further comprises identifying image voxels having large numbers of intersecting or nearly intersecting normal vectors.

3. The method as set forth in claim 1, wherein said medical image is a computed tomography image.

4. The method as set forth in claim 1, wherein said shapes are nodules.

5. The method as set forth in claim 1, wherein said shapes are lesions.

6. The method as set forth in claim 1, wherein said shapes are polyps.

7. The method as set forth in claim 1, wherein said shapes comprise pre-cancerous cells.

8. The method as set forth in claim 1, wherein said shapes are cancerous cells.

9. The method as set forth in claim 1, wherein said locating a surface further comprises pre-processing said medical image.

10. The method as set forth in claim 1, wherein said locating a surface further comprises segmenting said medical image.

11. The method as set forth in claim 1, wherein said generating a plurality of normal vectors further comprises applying gradient edge detection.

12. The method as set forth in claim 1, further comprising scaling of said plurality of normal vectors.

13. The method as set forth in claim 12, wherein said scaling comprises scaling the length of said plurality of normal vectors.

14. The method as set forth in claim 12, wherein said scaling comprises scaling the width of said plurality of normal vectors.

15. The method as set forth in claim 12, wherein said scaling is dependent on the type of said shapes.

16. The method as set forth in claim 12, wherein said scaling comprises a convolution of a gaussian distribution to said plurality of normal vectors.

17. The method as set forth in claim 1, wherein said detection of shapes is optimized for high detection sensitivity and high false positive elimination.

18. A computer-implemented method for automatically detecting shapes in a computed tomography medical image, comprising:
(a) locating a surface in said computed tomography medical image;
(b) generating a plurality of normal vectors to said surface, wherein said plurality of normal vectors are scaled according to the type of said shapes; and
(c) identifying at least one intersection or near intersection of said normal vectors.

19. The method as set forth in claim 1, wherein said identifying further comprises identifying image voxels having large numbers of intersecting or nearly intersecting normal vectors.

20. The method as set forth in claim 1, wherein said shapes are nodules.

21. The method as set forth in claim 1, wherein said shapes are lesions.

22. The method as set forth in claim 1, wherein said shapes are polyps.

23. The method as set forth in claim 1, wherein said shapes comprise pre-cancerous cells.

24. The method as set forth in claim 1, wherein said shapes are cancerous cells.

25. The method as set forth in claim 1, wherein said locating a surface further comprises pre-processing said computed tomography medical image.

26. The method as set forth in claim 1, wherein said locating a surface further comprises segmenting said computed tomography medical image.

27. The method as set forth in claim 1, wherein said generating a plurality of normal vectors further comprises applying gradient edge detection.

28. The method as set forth in claim 1, wherein said scaling comprises scaling the length of said plurality of normal vectors.

29. The method as set forth in claim 1, wherein said scaling comprises scaling the width of said plurality of normal vectors.

30. The method as set forth in claim 1, wherein said scaling comprises a convolution of a gaussian distribution to said plurality of normal vectors.

31. The method as set forth in claim 1, wherein said detection of shapes is optimized for high detection sensitivity and high false positive elimination.
